(19) United States
(12) Patent Application Publication
(10) Pub. No.: US 2009/0256993 A1
(43) Pub. Date: Oct. 15, 2009

(54) LIGHT DIFFUSER PLATE WITH LIGHT-COLLECTING LAYER

(75) Inventor: Hisanori Oku, Niihama-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Tokyo (JP)

(21) Appl. No.: 12/407,813

(22) Filed: Mar. 20, 2009

(30) Foreign Application Priority Data
Mar. 24, 2008 (JP) 2008-075959

(51) Int. Cl. G02F 1/1335; F21S 8/10; G02F 1/13357

(52) U.S. Cl. 349/61; 362/317; 362/97.1

(57) ABSTRACT

There is provided a light diffuser plate with a light-collecting layer which can be sufficiently prevented from flawing and which can ensure a sufficient luminance in the front direction. Such a light diffuser plate with a light-collecting layer comprises a light-collecting sheet 41, and a light-diffusing substrate 31 having an uneven surface 34 at its one side, said uneven surface 34 having a plurality of protrusions 32 formed thereon, and flat portions 33 with lengths of 5 μm or more, each formed between the adjacent protrusions 32, and is characterized in that said light-diffusing substrate 31 and said light-collecting sheet 41 are laminated on each other by jointing the protrusions 32 of the uneven surface of said light-diffusing substrate 31 to one surface of said light-collecting sheet 41 through an adhesive layer 40; air layers 42 are formed between the adhesive layer 40 and the flat portions 33 of the uneven surface of said light-diffusing substrate 31; and the total contact area of the protrusions 32 and the adhesive layer 40 is set at from 1 to 25% of the laminated area of said light-diffusing substrate 31 and said light-collecting sheet 41.

This application is filed claiming the Paris Convention priority of Japanese Patent Application No. 2008-075959, the entire content of which is herein incorporated by reference.

### FIELD OF THE INVENTION

The present invention relates to a light diffuser plate with a light-collecting layer, sufficiently prevented from flawing and capable of ensuring a sufficient luminance in the front direction. In particular, the present invention pertains to the light diffuser plate with the light-collecting layer, and a high quality surface light source device and a high quality liquid crystal display device, each of which can show a sufficient luminance in the front direction by comprising the same light diffuser plate.

### BACKGROUND OF THE INVENTION

For example, there is known a liquid crystal display device in which a surface light source device as a backlight is disposed on the rear side of a liquid crystal panel (i.e., an image-displaying member) comprising a liquid crystal cell. As the surface light source device as the backlight, there is known a surface light source device which comprises a plurality of light sources disposed in a lamp box (or a casing), a light diffuser plate disposed on the front side of the light sources, and lenticular lenses as a light-collecting sheet, disposed on the front side of the light diffuser plate so as to ensure a sufficient luminance in the front direction. For example, Patent Publication 1 discloses a surface light source device having the above-described structure.

Patent Publication 1: Japanese Patent No. 3123006

### DISCLOSURE OF THE INVENTION

### Problem to be Solved by the Invention

However, the above-described surface light source device has a problem in that the light diffuser plate and the light-collecting sheet rub on each other and are subject to flaws, since the light-collecting sheet is simply superposed on the front side of the light diffuser plate.

The present invention is developed in consideration of the above-described technical background. Objects of the present inventions are therefore to provide a light diffuser plate with a light-collecting layer, sufficiently prevented from flawing and capable of ensuring a sufficient luminance in the front direction, and a high quality surface light source device and a high quality liquid crystal display device, each of which can show a sufficient luminance in the front direction.

### Means for Solving the Problem

To achieve the objects, the present invention provides the following means.

[1] A light diffuser plate with a light-collecting layer, comprising

a light-collecting sheet, and

a light-diffusing substrate having an uneven surface at its one side, said uneven surface comprising a plurality of protrusions formed thereon, and flat portions with lengths of 5 μm or more, each formed between the adjacent protrusions,

characterized in that

said light-diffusing substrate and said light-collecting sheet are laminated on and united to each other by jointing the protrusions of the uneven surface of said light-diffusing substrate to one surface of said light-collecting sheet through an adhesive layer;

air layers are formed between the adhesive layer and the flat portions of the uneven surface of said light-diffusing substrate; and

the total contact area of the protrusions and the adhesive layer is from 1 to 25% of the laminated area of said light-diffusing substrate and said light-collecting sheet.

[2] The light diffuser plate with the light-collecting layer, defined in the above-described item 1, wherein the height of each of the protrusions is set to be higher than the thickness of the adhesive layer, and wherein said light-diffusing substrate and said light-collecting sheet are laminated on each other so that the adhesive layer is not allowed to contact the flat portions of the uneven surface of said light-diffusing substrate.
[3] The light diffuser plate with the light-collecting layer, defined in the above-described item 1 or 2, wherein the protrusions are disposed in a scattered state in plan view, on the entire uneven surface.
[4] A surface light source device comprising the light diffuser plate with the light-collecting layer, defined in any one of the above-described items 1 to 3, and a plurality of light sources disposed on the rear side of said light diffuser plate, characterized in that said light-collecting sheet of said light diffuser plate is disposed on the front side.
[5] A liquid crystal display device comprising the light diffuser plate with the light-collecting layer, defined in any one of the above-described items 1 to 3, a plurality of light sources disposed on the rear side of the light diffuser plate, and a liquid crystal panel disposed on the front side of the light diffuser plate, characterized in that the light-collecting sheet of the light diffuser plate is disposed on the front side.

### EFFECT OF THE INVENTION

According to the invention of the item [1], the protrusions of the uneven surface of the light-diffusing substrate and one surface of the light-collecting sheet are jointed to each other through the adhesive layer, and therefore, the light-diffusing substrate and the light-collecting sheet do not rub on each other, so that flawing of the light diffuser plate can be sufficiently prevented. Further, the air layers are formed between the adhesive layer and the flat portions of the uneven surface of the light-diffusing substrate, and therefore, a luminance in the front direction can be sufficiently ensured. Furthermore, the total contact area of the protrusions and the adhesive layer is set at from 1 to 25% of the laminated area of the light-diffusing substrate and the light-collecting sheet, and therefore, a sufficient joint strength can be ensured, and a luminance in the front direction can be more improved. Still furthermore, the air layers can be formed simply by laminating the light-diffusing substrate having the above-specified uneven surface at its one side on the light-collecting sheet through the adhesive layer, and therefore, the protrusions of the light-diffusing substrate can serve as spacers to ensure the air layers, upon the lamination of the light-diffusing substrate on the light-collecting sheet, which leads to higher productivity.

According to the invention of the item [2], the height of each of the protrusions is set to be higher than the thickness of the adhesive layer, and therefore, contact of the adhesive layer to the flat portions of the uneven surface of the light-diffusing substrate can be surely prevented, so that sufficient air layers can be ensured to improve the luminance in the front direction.

According to the invention of the item [3], the protrusions are disposed in a scattered state in plan view, on the entire uneven surface, and therefore, any influence of such protrusions on the optical function of the light diffuser plate with the light-collecting layer can be avoided, and thus, any influence on the picture quality of a displayed picture image can be sufficiently avoided.

According to the invention of the item [4], there is provided a surface light source device which suffers from no flawing of the light diffuser plate with the light-collecting layer and thus can emit high quality light and show a high luminance in the front direction.

According to the invention of the item [5], there is provided a liquid crystal display device which suffers from no flawing of the light diffuser plate with the light-collecting layer and thus can display a high quality picture image and show a high luminance in the front direction.

### BRIEF DESCRIPTION OF THE DRAWINGS

FIG. 1 shows a schematic diagram of an embodiment of a liquid crystal display device according to the present invention.

FIG. 2 shows a perspective view of an embodiment of a light diffuser plate with a light-collecting layer according to the present invention.

FIG. 3 shows a sectional view of the light diffuser plate shown in FIG. 2, taken along line X-X.

FIG. 4 shows a sectional view of a light-diffusing substrate.

FIG. 5 shows plan views of light-diffusing substrates constituting light diffuser plates with light-collecting layers according to other embodiments of the present invention.

### DESCRIPTION OF REFERENCE NUMERALS

1=a surface light source device
2=a light source
3=a light diffuser plate
20=a liquid crystal panel
30=a liquid crystal display device
31=a light-diffusing substrate
32=a protrusion
33=a flat portion
34=an uneven surface
40=an adhesive layer
41=a light-collecting sheet
42=an air layer
H=a height of the protrusion
L=a length of the flat portion (or a distance between the adjacent protrusions)
M=a thickness of the adhesive layer

### DETAILED DESCRIPTION OF THE INVENTION

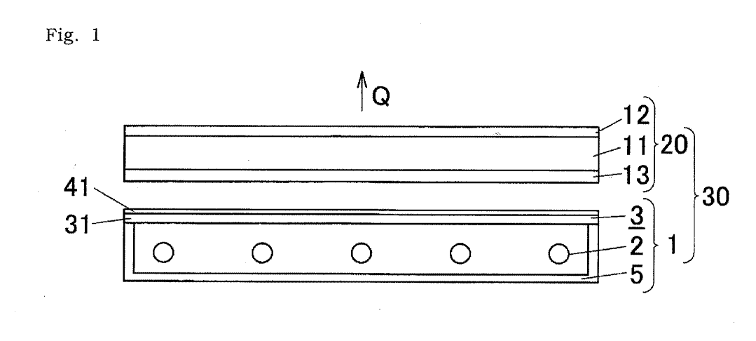

An embodiment of a liquid crystal display device according to the present invention is illustrated in FIG. 1. In FIG. 1, numeral (30) refers to a liquid crystal display device; (11), to a liquid crystal cell; (12) and (13), to polarizing plates; and (1), to a surface light source device (i.e., a backlight). The polarizing plates (12) and (13) are disposed on the upper and lower sides of the liquid crystal cell (11), respectively, so that these members (11), (12) and (13) constitute a liquid crystal panel (20) as an image display member. As the liquid crystal cell (11), such one that can display a colored image is preferably used.

The surface light source device (1) is disposed on the lower side of the polarizing plate (13) on the lower side of the liquid crystal panel (20) (i.e., on the rear side of the liquid crystal panel). In other words, this liquid crystal display device (30) is a direct type liquid crystal display device.

The surface light source device (1) comprises a lamp box (5) in the shape of a casing with a low height, which is opened at its upper side (or the front side) and is seen to be rectangular in plan view; a plurality of light sources (2) spaced to one another in the lamp box (5); and a light diffuser plate (3) disposed on the upper side (or the front side) of the plurality of light sources (2). The light diffuser plate (3) is so fixed to the lamp box (5) as to close the opening of the lamp box (5). Further, a light-reflecting layer (not shown) is provided on the inner surfaces of the lamp box (5). In this embodiment, linear light sources such as cold cathode ray tubes or the like are used as the light sources (2).

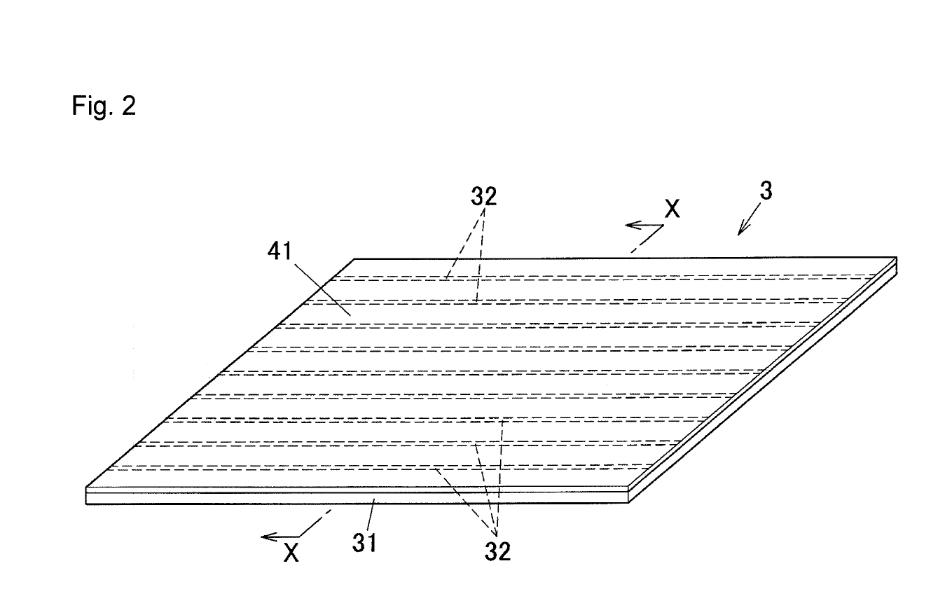

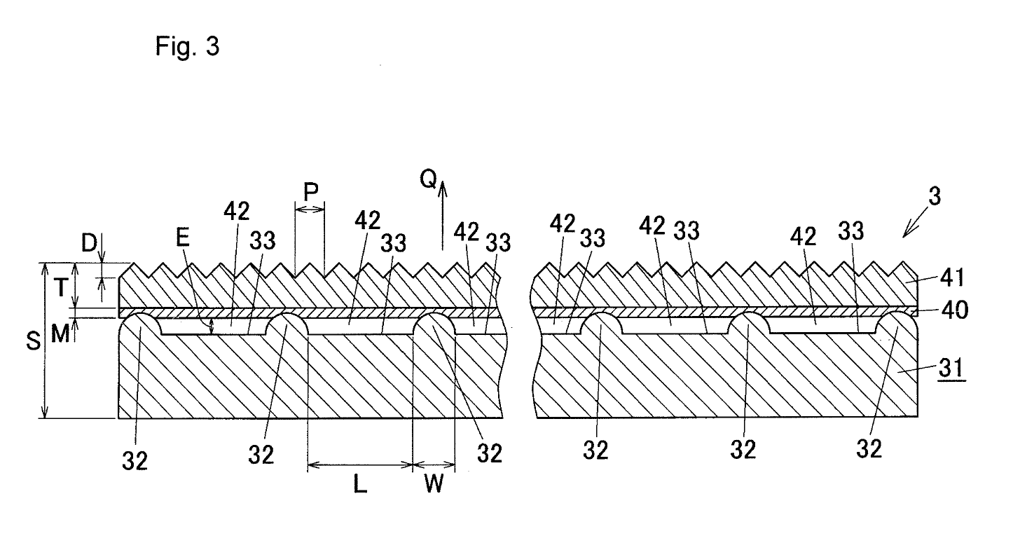

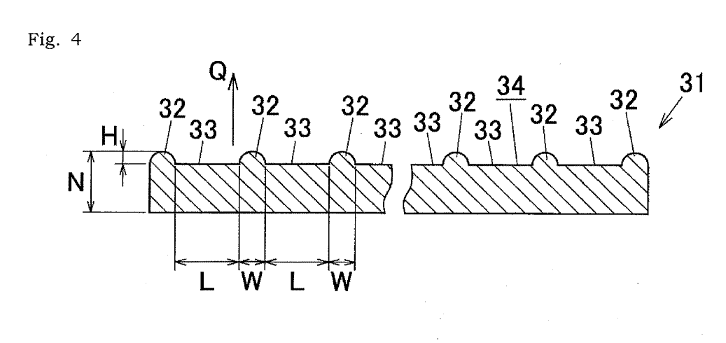

The light diffuser plate (3) comprises, as shown in FIGS. 2 and 3, a light-diffusing substrate (31), a light-collecting sheet (41) and an adhesive layer (40). The light-diffusing substrate (31) has an uneven surface (34) at its one side (see FIG. 4), which comprises a plurality of protrusions (32) formed on its surface, and flat portions (33) with lengths (L) of 5 μm or more, each formed between the adjacent protrusions (32). The protrusions (32) of the uneven surface (34) of the light-diffusing substrate (31) are bonded to one surface of the light-collecting sheet (41) through the adhesive layer 40). Thus, the light-diffusing substrate (31) and the light-collecting sheet (41) are laminated on and united to each other (see FIG. 3), so that air layers (42) are formed between the adhesive layer (40) and the flat portions (33) of the uneven surface (34) of the light-diffusing substrate (31). The adhesive layer (40) is laminated on the substantially entire area of one surface of the light-collecting sheet (41) without any clearance therebetween.

In this embodiment, the section of each of the protrusions (32) has a substantially semicircular shape (see FIGS. 3 and 4). As shown in FIG. 2, the plurality of protrusions (32) are disposed in a scattered state in plan view, on the entire surface. That is, in this embodiment, the protrusions (32) are cylindrical lens-shaped ridges (in the shape of a half-cut cylinder) which extend along one direction in parallel to the surface of the light-diffusing substrate (31), and these cylindrical lens-shaped ridges (32) are disposed in parallel to one another in the lengthwise direction (or the axial direction) (see FIG. 2). The term of “cylindrical lens-shaped” means the shape of either half of a substantially cylindrical body, obtained by cutting the cylindrical body along a plane in parallel to its axial direction (or lengthwise direction) (or a plane including the axial line or a plane including no axial line).

In this embodiment, the cylindrical lens-shaped ridges (32) are half-cut cylindrical protrusions, having a shape equivalent to the shape of one of the halves obtained by evenly cutting a cylindrical body along a plane including its axial line.

Again, in this embodiment, linear light sources are used as the above-described light sources (2), and the lengthwise directions of the linear light sources (2) and the lengthwise directions of the cylindrical lens-shaped ridges (32) of the light-diffusing substrate (31) are substantially coincident with each other. The lengthwise directions of the cylindrical lens-shaped ridges (32) are also substantially coincident with the lengthwise direction of the light diffuser plate (3) (see FIG. 2).

Again, in this embodiment, the height (H) of each of the protrusions (32) is so designed as to be higher than the thickness (M) of the adhesive layer (40) (see FIGS. 3 and 4), so that the adhesive layer (40) is not allowed to contact the flat portions (33) of the uneven surface (34) of the light-diffusing substrate (31) (see FIG. 3).

In the above-described liquid crystal display device (30), the light diffuser plate (3) is so disposed that its light-collecting sheet (41) can be on the front side (on the side of the liquid crystal panel (20)) (see FIG. 1). In other words, in the liquid crystal display device (30), the light diffuser plate (3) is so disposed that its light-diffusing substrate (31) can be on the rear side (on the side of the light sources (2)) (see FIG. 1).

The light diffuser plate (3) with the above-described structure can be sufficiently prevented from flawing, since the light-diffusing substrate (31) and the light-collecting sheet (41) do not rub on each other because of the joint of the protrusions (32) of the uneven surface (34) of the light-diffusing substrate (31) to one surface of the light-collecting sheet (41) through the adhesive layer (40). Again, the light diffuser plate (3) with the above-described structure makes it possible for the surface light source device (1) to illuminate at a high luminance in the front direction (or the normal line direction) (Q), and makes it possible for the liquid crystal display device (30) to display a picture image at a high luminance in the front direction (or the normal line direction) (Q), since the air layers (42) are formed between the adhesive layer (40) and the flat portions (33) of the uneven surface (34) of the light-diffusing substrate (31). Further, the protrusions (32) are disposed in a scattered state in plan view, on the entire surface, and therefore, the optical function of the light diffuser plate (3) with the light-collecting layer is not adversely influenced by the protrusions (32) disposed as such, so that a high quality picture image can be displayed.

In the present invention, as the light-diffusing substrate (31), any material that can diffuse transmitted light may be used. Above all, a plate obtained by dispersing light diffuser particles (i.e., a light-diffusing agent) in a transparent material is preferably used.

While the light-diffusing substrate (31) is not limited, for example, there is used a single plate made of a transparent resin, or a lamination plate which comprises a base layer formed of a transparent resin, and one or more other layer(s) formed of different transparent resin(s) and laminated on at least one surface of the base layer.

While the transparent material constituting the light-diffusing substrate (31) is not limited, for example, transparent resins, inorganic glass, etc. are used. Preferably used as the transparent resin is a transparent thermoplastic resin because of its facility for molding. While the transparent thermoplastic resin is not limited, for example, there are exemplified polycarbonate resins, ABS resins (or acrylonitrile-butadiene-styrene copolymer resins), methacrylic resins, MS resins (or methyl methacrylate-styrene copolymer resins), styrene resins, AS resins (or acrylonitrile-styrene copolymer resins), polyethylene terephthalate, olefin resins (e.g., polyethylene, polypropylene, cyclic polyolefin, cyclic olefin copolymers, etc.) and the like.

While the above-described light diffuser particles are not limited, there can be used any kind of particles that are incompatible with the transparent resin constituting the light-diffusing substrate (31) and have a different refractive index from that of the transparent resin, and can diffuse transmitted light. Examples of the light diffuser particles include inorganic particles such as silica particles, calcium carbonate particles, barium sulfate particles, titanium oxide particles, aluminum hydroxide particles, inorganic glass particles, mica particles, talc particles, white carbon particles, magnesium oxide particles and zinc oxide particles; and organic particles such as methacrylic crosslinked resin particles, methacrylic polymeric resin particles, styrenic crosslinked particles, styrenic polymeric resin particles and siloxane-based polymer particles. At least one kind of particles of the above-described particles, or two ore more kinds of particles thereof as a mixture may be used as the light diffuser particles.

In general, the light diffuser particles having a volume-average particle size of from 0.1 to 50 μm are used. The volume-average particle size (D₅₀) is the particle size of a particle determined as follows: the particle sizes and volumes of all the particles are measured; and the volumes of the particles are integrated in the order of a particle with the smallest particle size, to find an integrated volume which is 50% of the total volume of all the particles; and the particle size of the particle found when the integrated volume reaches 50% of the total volume is measured.

The amount of the light diffuser particles to be used may be changed in accordance with an intended degree of diffusion of transmitted light. Usually, 0.01 to 20 parts by mass of the light diffuser particles are contained in 100 parts by mass of the transparent resin. Preferably, 0.1 to 10 parts by mass of the light diffuser particles are contained in 100 parts by mass of the transparent resin.

The absolute value of a difference between the refractive index of the transparent resin and that of the light diffuser particles is preferably 0.02 or more, in view of a light-diffusing property; and this absolute value is preferably 0.13 or less, in view of light transmission. That is, the absolute value of a difference between the refractive index of the transparent resin and that of the light diffuser particles is preferably from 0.02 to 0.13.

A variety of additives such as a UV absorber, a thermal stabilizer, an antioxidant, a weathering agent, a light stabilizer, a fluorescent brightener, a processing stabilizer, etc. may be added to the light-diffusing substrate (31).

The thickness (N) of the light-diffusing substrate (31) is usually set at from 0.1 to 10 mm.

In the present invention, one surface of the light-diffusing substrate (31) is formed as the uneven surface (34) which comprises the plurality of protrusions (32) and the flat portions (33) with lengths (L) of 5 μm or more, each formed between the adjacent protrusions (32) (see FIG. 4).

While the shape of the section of each of the protrusions (32) is not limited, the sectional shape of the protrusion may be, for example, substantially semicircular, semi-elliptic or polygonal (e.g., rectangular or triangular).

In this embodiment, the sectional shape of each protrusion (32) is semicircular, and is laterally symmetric about a normal line passing through the center of this circle (i.e., a line perpendicular to a horizontal plane). However, the sectional shape of each protrusion is not limited to such, and may be laterally asymmetric: for example, the sectional shape thereof may be laterally asymmetric such that the left circular arc is curved more on the front side than the right circular arc. When the sectional shape of each protrusion (32) is triangular, this triangle may be a laterally symmetric isosceles triangle or a laterally asymmetric triangle.

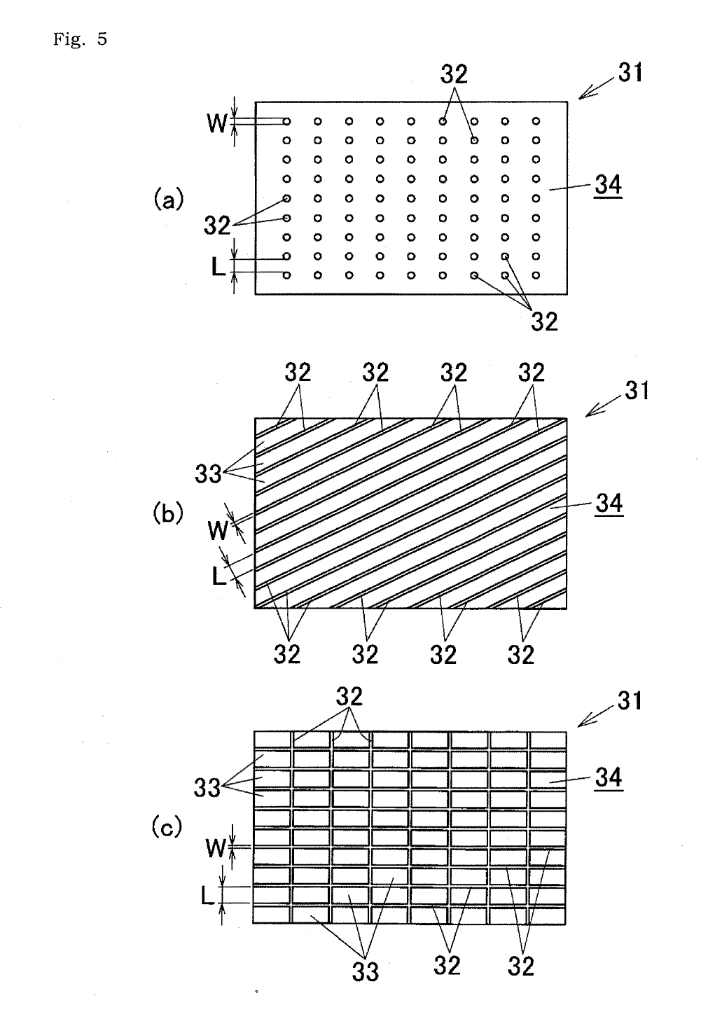

Preferably, the protrusions (32) are disposed in a scattered state in plan view, on the entire surface. In this embodiment, as one example of such, scattered arrangement of cylindrical lens-shaped ridges (or substantially half-cut cylindrical ridges) is employed. However, the arrangement of the protrusions is not limited to this one. Other examples of the scattered arrangement of the protrusions (32) in plan view on the entire surface are shown in FIG. 5: for example, as shown in FIG. 5(a), a lot of dot-like portions (or dot portions) may be scattered on the entire surface in plan view; or as shown in FIG. 5(b), cylindrical lens-shaped ridges (32) may be disposed stripe-like and obliquely to the lengthwise direction of the light diffuser plate (3); or as shown in FIG. 5(c), cylindrical lens-shaped ridges (32) may be lattice-like disposed in plan view.

While the method for forming the protrusions (32) is not limited, there is employed, for example, heat transfer using a mold, injection molding, cutting, profile extrusion molding, melt extrusion transfer molding using a carved roll, or the like.

Preferably, the height (H) of the protrusions (32) is set at 10 to 500 μm. The protrusions (32) with a height of 10 μm or more have a sufficient spacer function to ensure sufficient clearances for the air layers (42). When the height is 500 μm or less, the shaping of the protrusions (32) is facilitated.

Preferably, the size of the protrusions (32) (or the width of the lines, if the protrusions are stripe-like or lattice-like formed in plan view, or the major axis, if they are dot-like formed) (W) is set at 10 to 500 μm. When this size is 10 μm or more, a sufficient joint strength can be ensured. When this size is 500 μm or less, the influence of the protrusions (32) on a displayed picture image can be fully eliminated. It is particularly preferable to set the size of the protrusions (32) at 50 to 300 μm.

In the above-described uneven surface (34), each of the flat portions (33) with lengths (L) of 5 μm or more in the horizontal direction is formed between the adjacent protrusions (32). When the length (L) of this flat portion (33) is smaller than 5 μm, the clearance for the air layer (42) between the adhesive layer (40) and the flat portion (33) of the light-diffusing substrate (31) becomes insufficient. Consequently, a luminance in the front direction can not be sufficiently obtained. It is particularly preferable to set the length (L) of the flat portions (33) at 100 to 4,000 μm. When this length exceeds 4,000 μm, there may be a disadvantage that the adhesive layer (40) is likely to contact the flat portions (33) of the light-diffusing substrate (31), which undesirably leads to a decrease in the volumes of the clearances for the air layers (42).

Preferably, the ratio of the length (L) of the flat portion (33) to the size (W) of the protrusion (32), i.e., L/W, is set at 0.4 or more. When the ratio of L/W is 0.4 or more, the luminance in the front direction can be more improved. It is particularly preferable to set the ratio of L/W at 0.4 to 15.

While the above-described light-collecting sheet (41) is not limited, for example, there is used a sheet whose one side has fine light-collecting lenses such as fine prism lenses, fine convex lenses or lenticular lenses entirely formed thereon. Light which passes through the light-diffusing substrate (31) while being diffused is converged by the light-collecting sheet (41), in a normal line direction (Q) to the light diffuser plate (3). A surface of the light-collecting sheet (41), opposite the surface thereof having the light-collecting lenses formed thereon, is used as the joint face and is laminated on and united to the light-diffusing substrate (31) (see FIG. 3).

Examples of a material for the light-collecting sheet (41) include, but not limited to, polycarbonate resins, ABS resins (or acrylonitrile-butadiene-styrene copolymer resins), methacrylic resins, methyl methacrylate-styrene copolymer resins, polystyrene resins, AS resins (or acrylonitrile-styrene copolymer resins), polyolefin resins (e.g., polyethylene resins, polypropylene resins, etc.) and the like. While there is no limit in selection of commercially available products of the light-collecting sheet (41), there are exemplified “BEF®” manufactured by SUMITOMO 3M LIMITED (a laminate comprising a polyester film with a thickness of 125 μm and an acrylic resin layer with a thickness of 30 μm which is formed on the polyester film and which has V-shaped grooves with depths (D) of 25 μm and with opening angles of 90 (at the bottom, formed at pitch intervals (P) of 50 μm on its surface) (see FIG. 3); “ESTINA®” manufactured by SEKISUI FILM CO., LTD., etc.

The light-collecting sheet (41) may contain a variety of additives, for example, a UV absorber, a thermal stabilizer, an antioxidant, a weathering agent, a light stabilizer, a fluorescent brightener, a processing stabilizer, etc.

The thickness (T) of the light-collecting sheet (41) is usually set at from 0.02 to 5 mm, and it is preferably from 0.02 to 2 mm.

Examples of a material for the adhesive layer (40) include, but not limited to, acrylic adhesives, urethane-based adhesives, polyether-based adhesives and silicone-based adhesives. Among those, a colorless and transparent adhesive is preferably used in order to obtain a higher quality displayed picture image. In general, a pressure sensitive adhesive is used for the adhesive layer (40). In this regard, the refractive index of the adhesive is not limited.

Preferably, the thickness (M) of the adhesive layer (40) is set at 10 to 30 μm. The use of the adhesive layer with a thickness of 10 μm or more is effective to ensure a sufficient joint strength, and the use of the adhesive layer with a thickness of 30 μm or less is effective to sufficiently prevent the adhesive layer (40) from contacting the flat portions (33) of the light-diffusing substrate (31) to thereby ensure sufficient clearance volumes for the air layers (42). It is particularly preferable to set the thickness (M) of the adhesive layer (40) at 5 to 25 μm.

The thickness (E) of the air layers (42) is usually set at 1 to 400 μm, preferably 50 to 350 μm.

In the present invention, the total contact area of the above-described protrusions (32) and the above-described adhesive layer (40) (i.e., the total contact area in plan view) is set at 1 to 25% of the lamination area of the above-described light-diffusing substrate (31) and the above-described light-collecting sheet (41). When this total contact area is less than 1%, a sufficient joint strength can not be ensured. When the total contact area exceeds 25%, a sufficient luminance in the front direction can not be obtained. The total contact area is set at preferably 8 to 23%, particularly 10 to 20%.

For example, the light diffuser plate (3) of the present invention is fabricated as follows. A pressure sensitive adhesive double coated film is applied to one surface of the light-collecting sheet (41) to thereby laminate the adhesive layer (40) on the one surface of the light-collecting sheet (41) so that the light-collecting sheet with the adhesive is obtained. It is of course allowed to apply an adhesive to one surface of the light-collecting sheet (41) to thereby laminate the adhesive layer (40) on the one surface of the light-collecting sheet (41). On the other hand, the light-diffusing substrate (31) is fabricated which has the uneven surface (34) at its one side, wherein the uneven surface (34) has a plurality of protrusions (32) formed thereon and flat portions (33) with lengths (L) of 5 μm or more, each formed between the adjacent protrusions (32) (see FIG. 4). The light-diffusing substrate (31) and the light-collecting sheet (41) with the adhesive are laminated and pressed on each other so that the adhesive layer (40) is allowed to contact the uneven surface (34) of the light-diffusing substrate (31). Thus, the protrusions (32) of the light-diffusing substrate (31) are bonded to one surface of the light-collecting sheet (41) by the adhesive layer (40) to obtain the light diffuser plate (3) with the light-collecting layer according to the present invention.

The above-described method is illustrative only, and thus does not limit the method for manufacturing the light diffuser plate (3) with the light-collecting layer of the present invention in any way.

While the thickness (S) of the light diffuser plate (3) of the present invention is not limited, it is preferably set at 1 to 5 mm. The size (or area) of the light diffuser plate (3) of the present invention is also not limited. For example, the size of the light diffuser plate (3) may be appropriately selected according to the size of an intended surface light source device (1) or liquid crystal display device (30). It is usually set at a size of from 20 cm×30 cm to 150 cm×200 cm.

In the surface light source device (1) and the liquid crystal display device (30) of the present invention, the kind of the light sources (2) is not limited. For example, spot light sources such as light-emitting diodes (or LEDs) are used, other than the linear light sources such as fluorescent lamps, halogen lamps and tungsten lamps.

The light diffuser plate (3), the surface light source device (1) and the liquid crystal display device (30) of the present invention are not limited to the above-described embodiments, and may be altered and modified in their designs within the scope of the claims, in so far as such alternation and modification do not depart from the spirit of the present invention.

### EXAMPLES

Next, the specific examples of the present invention will be described, which however do not limit the scope of the present invention in any way.

### <Raw Materials>

### (Materials for Light-Diffusing Substrate)

Transparent resin A: a styrene resin (“HRM40” manufactured by TOYO STYRENE CO., LTD.; refractive index: 1.59)
Transparent resin B: a MS resin (“MS200NT” manufactured by
Nippon Steel Chemical Co., Ltd.; refractive index: 1.57; styrene/methyl methacrylate=80 parts by mass/20 parts by mass)
Light-diffusing agent A: PMMA crosslinked particles (“SUMIPEX XC1A” manufactured by Sumitomo Chemical Company, Limited; refractive index: 1.49; weight-average particle size: 35 μm)
Light-diffusing agent B: Crosslinked siloxane-based polymer particles (“Trefil DY33-719” manufactured by Dow Corning Toray; refractive index: 1.42; volume-average particle size: 2 μm)

### Light-Diffusing Agent Master Batch A:

The transparent resin A (52.0 parts by mass), the light-diffusing agent A (40.0 parts by mass), the light-diffusing agent B (4.0 parts by mass), Sumisorb 200 as a UV absorber (manufactured by Sumitomo Chemical Company, Limited) (2.0 parts by mass) and Sumilizer GP as a thermal stabilizer (manufactured by Sumitomo Chemical Company, Limited) (2.0 parts by mass) were dry-blended. Then, this blend was charged in the hopper of a 65 mm twin-screw extruder and was melt-kneaded in the cylinder thereof. After that, this knead mixture was strand-like extruded and pelletized. Thus, a pelletized light-diffusing agent master batch A was obtained. In this regard, the inner temperature of the cylinder was gradually raised downstream for extrusion, from 200° C. at the lower side of the hopper to 250° C. around the extrusion die.

### Light-Diffusing Agent Master Batch B:

The transparent resin B (78.8 parts by mass), the light-diffusing agent A (20.0 parts by mass), LA-31 as a UV absorber (manufactured by ASAHI DENKA KOGYO K.K.) (1.0 part by mass) and Sumilizer GP as a thermal stabilizer (manufactured by Sumitomo Chemical Company, Limited) (0.2 parts by mass) were dry-blended. Then, this blend was charged in the hopper of a 65 mm twin-screw extruder and was melt-kneaded in the cylinder thereof. After that, this knead mixture was strand-like extruded and pelletized. Thus, a pelletized light-diffusing agent master batch B was obtained. In this regard, the inner temperature of the cylinder was gradually raised downstream for extrusion, from 200° C. at the lower side of the hopper to 250° C. around the extrusion die.

### (Light-Collecting Sheet A)

There was used a film with a thickness (T) of 60 μm formed of a transparent PET (polyethylene terephthalate) resin, wherein V-shaped grooves having a depth (D) of 11.5 μm and an opening angle of 90° to the bottom were formed at pitch intervals (P) of 23.0 μm on one surface of the film.

### Example 1

The transparent resin A (97.0 parts by mass) and the light-diffusing agent master batch A (5.0 parts by mass) were dry-blended, and this blend was melt-kneaded at an inner temperature of 190 to 250° C. in the cylinder of a first extruder. This knead mixture was supplied to a feed block. On the other hand, the light-diffusing agent master batch B was melt-kneaded at an inner temperature of 190 to 250° C. in the cylinder of a second extruder, and this knead mixture was supplied to the feed block.

The resin supplied from the first extruder to the feed block and the resin supplied from the second extruder to the feed block were co-extruded from a multi-manifold die while the extruded resins being maintained at 250° C., so that the resin supplied from the first extruder to the feed block was shaped into an intermediate layer (i.e., a base layer), and so that the resin supplied from the second extruder to the feed block was shaped into surface layers (i.e., both surfaces). The extruded layers were compressed with polishing rolls and cooled to obtain a light-diffusing substrate (31) consisting of a three-layered lamination plate (the intermediate layer: 1.9 mm; and the surface layers: 0.05 mm×2).

Next, a plurality of cylindrical lens-shaped ridges (substantially semi-circular cylindrical ridges) (32) were formed along the lengthwise direction of the light-diffusing substrate (31) entirely on one surface of the light-diffusing substrate (31), using a hot press (Shindo system ASF type hydraulic press manufactured by SHINTO Metal Industries Corporation). Thus, the light-diffusing substrate (31) with a thickness (N) of 2.0 mm (see FIGS. 2 to 4) was obtained. In this regard, a plurality of grooves corresponding to the above-described ridges were shaped on the underside (the press plane) of the metal mold on the upper side of the hot press. The hot pressing by the use of the hot press was carried out for about 3 minutes, with the temperature of the upper side of the hot press set at 160° C. and the temperature of the lower side thereof, at 70° C.

The uneven surface (34) of the light-diffusing substrate (31), thus obtained, comprised the protrusions (32) with a height (H) of 150 μm and a size (i.e., the length of the base of the protrusion) (W) of 342 μm formed at even pitch intervals, and the flat portions with a length (i.e., the interval between the adjacent protrusions) (L) of 162 μm, wherein the ratio of L/W was 0.47 (see FIG. 4).

On the other hand, a pressure sensitive adhesive double coated film was applied to one surface of the light-collecting sheet A (41) to thereby laminate the adhesive layer (40) with a thickness (M) of 20 μm on the one surface of the light-collecting sheet A (41). Thus, the light-collecting sheet with the adhesive was obtained.

The light-diffusing substrate (31) was laminated on the light-collecting sheet (41) with the adhesive, so that the uneven surface (34) of the light-diffusing substrate (31) could be in contact with the adhesive layer (40), and both of them were compressed to obtain the light diffuser plate (3) with the light-collecting layer, having the cross section shown in FIG. 3.

In this light diffuser plate (3) with the light-collecting layer, air layers (42) with a thickness (E) of 140 μm were formed between the adhesive layer (40) and the flat portions (33) of the light-diffusing substrate (31), as shown in FIG. 3. The ratio of the area of the adhesive region in plan view (i.e., the ratio of the total contact area of the protrusions and the adhesive layer, to the laminated area of the light-diffusing substrate and the light-collecting sheet) was 23%.

### Example 2

A light diffuser plate with a light-collecting layer was fabricated in the same manner as in Example 1, except for the use of a light-diffusing substrate (31) which had protrusions (32) with a height (H) of 150 μm and a size (the length of the base of the protrusion) (W) of 318 μm, and flat portions with a length (the interval between the adjacent protrusions) (L) of 339 μm, obtained by changing the shapes of the grooves formed on the underside (the pressing plane) of the metal mold on the upper side of the hot press, wherein the ratio of L/W was 1.07. The ratio of the area of the adhesive region in plan view was 16%.

### Example 3

A light diffuser plate with a light-collecting layer was fabricated in the same manner as in Example 1, except for the use of a light-diffusing substrate (31) which had protrusions (32) with a height (H) of 144 μm and a size (the length of the base of the protrusion) (W) of 309 μm, and flat portions with a length (the interval between the adjacent protrusions) (L) of 612 μm, obtained by changing the shapes of the grooves formed on the underside (the pressing plane) of the metal mold on the upper side of the hot press, wherein the ratio of L/W was 1.98. The ratio of the area of the adhesive region in plan view was 13%.

### Example 4

A light diffuser plate with a light-collecting layer was fabricated in the same manner as in Example 1, except for the use of a light-diffusing substrate (31) which had protrusions (32) with a height (H) of 144 μm and a size (the length of the base of the protrusion) (W) of 321 μm, and flat portions with a length (the interval between the adjacent protrusions) (L) of 807 μm, obtained by changing the shapes of the grooves formed on the underside (the pressing plane) of the metal mold on the upper side of the hot press, wherein the ratio of L/W was 2.51. The ratio of the are of the adhesive region in plan view was 9%.

### Comparative Example 1

A light diffuser plate with a light-collecting layer was fabricated in the same manner as in Example 1, except for the use of a light-diffusing substrate (31) which had protrusions (32) with a height (H) of 117 μm and a size (the length of the base of the protrusion) (W) of 317 μm, and flat portions with a length (the interval between the adjacent protrusions) (L) of 21 μm, obtained by changing the shapes of the grooves formed on the underside (the pressing plane) of the metal mold on the upper side of the hot press, wherein the ratio of L/W was 0.07. The ratio of the area of the adhesive region in plan view was 27%.

### Comparative Example 2

A light diffuser plate with a light-collecting layer was fabricated in the same manner as in Example 1, except for the use of a light-diffusing substrate (31) which had protrusions (32) with a height (H) of 150 μm and a size (the length of the base of the protrusion) (W) of 321 μm, and flat portions with a length (the interval between the adjacent protrusions) (L) of 115 μm, obtained by changing the shapes of the grooves formed on the underside (the pressing plane) of the metal mold on the upper side of the hot press, wherein the ratio of L/W was 0.36. The ratio of the area of the adhesive region in plan view was 26%.

### Comparative Example 3

A light diffuser plate with a light-collecting layer was fabricated in the same manner as in Example 1, except that the formation of protrusions (32) by using a hot press was not conducted on the light-diffusing substrate obtained by co-extrusion molding. That is, in this light diffuser plate, the light-diffusing substrate and the light-collecting sheet A were entirely bonded to each other by the adhesive layer, so that no air layer is formed between the light-diffusing substrate and the light-collecting sheet A.

The light diffuser plates with the light-collecting layers, thus obtained, were evaluated by the following methods. The results are shown in Table 1.

TABLE 1

| | Ratio of | | | | | | | | |
|---|---|---|---|---|---|---|---|---|---|
| | area of | Thickness M | Height H of | Thickness E | Size W of | Length L of | | | |
| | adhesive | of adhesive | protrusion | of air | protrusion | flat portion | | Uniformity in | Average luminance |
| | region* (%) | layer (μm) | (μm) | layer (μm) | (μm) | (μm) | L/W | luminance (%) | (cd/m²) |
| Ex. 1 | 23 | 20 | 150 | 140 | 342 | 162 | 0.47 | 99.3 | 5966.2 |
| Ex. 2 | 16 | 20 | 150 | 140 | 318 | 339 | 1.07 | 99.3 | 6085.6 |
| Ex. 3 | 13 | 20 | 144 | 134 | 309 | 612 | 1.98 | 99.3 | 6334.3 |
| Ex. 4 | 9 | 20 | 144 | 134 | 321 | 807 | 2.51 | 99.2 | 6321.5 |
| C. Ex. 1 | 27 | 20 | 117 | 107 | 317 | 21 | 0.07 | 99.2 | 5741.5 |
| C. Ex. 2 | 26 | 20 | 150 | 140 | 321 | 115 | 0.36 | 99.2 | 5718.4 |
| C. Ex. 3 | — | 20 | — | No air | — | — | — | 98.9 | 5709.7 |
| | | | | layer | | | | | |

*Ratio of area of adhesive region: a ratio (%) of the total contact area of the protrusions and the adhesive layer to the laminated area of the light-diffusing substrate and the light-collecting sheet

### <Average Luminance and Uniformity in Luminance>

A liquid crystal panel, a variety of optical films and a light diffuser plate were removed from a commercially available 20 in. liquid crystal television, and then, each of the above-fabricated light diffuser plates (Examples and Comparative Examples) was disposed in contact with the front of the frame of the lamp box (in which a plurality of fluorescent lamps were spaced to one another) and fixed thereto, and the opening of the lamp box was closed. After that, the luminance of the lamp box with the light diffuser plate set therein was measured with a luminance-measuring instrument (“Eye Scale-3WS” manufactured by I. System Corporation). The minimum value of luminance was defined as “C1”, and the maximum value of luminance was defined as “C2”, and a value calculated by the following equation was defined as uniformity in luminance (%)

Uniformity in luminance (%)=(C1/C2)×100.

The above-described luminance was measured as follows. A liquid crystal television was disposed with its front side faced upward (with its rear side in contact with the floor) on the floor of a dark room controlled at a constant temperature and a constant humidity (25.0° C., 50.0% RH). A camera was set at a position above the liquid crystal television so that the camera faced downward to take a picture of a whole of the front plane of the liquid crystal television. The distance from the front plane of the television to the camera was 65.0 cm. The measuring conditions for the luminance-measuring instrument were set as follows: SPEED: 1/500, GAIN: 5, and diaphragm: 16. A region of 60 mm×60 mm centering on the center portion of the front plane of the liquid crystal television was defined as a measuring spot (2,601 points), and the luminance of each of the points was measured. An average of these luminances was determined as an average luminance (cd/m²), and uniformity in luminance (%) was determined from the minimum value and the maximum value of luminance among these measured values.

As is apparent from Table 1, any of the surface light source devices comprising the light diffuser plates with the light-collecting layers of Examples 1 to 4 of the present invention could obtain a sufficiently high luminance in its front direction (a normal line direction) and was also excellent in uniformity in luminance. In any of the light diffuser plates with the light-collecting layers of Examples 1 to 4, the light-diffusing substrate and the light-collecting sheet were jointed to each other through the adhesive layer, so that the light-diffusing substrate and the light-collecting sheet did not rub on each other. Therefore, no scratch was caused in any of the light diffuser plates.

In contrast, the surface light source device comprising the light diffuser plate with the light-collecting layer of Comparative Example 3 could not obtain a sufficient luminance in its front direction (a normal line direction), since no air layer was formed between the light-diffusing substrate and the light-collecting sheet, because of the entire bonding thereof with the adhesive.

Also, the surface light source device comprising the light diffuser plate with the light-collecting layer of Comparative Example 1 or 2 could not obtain a sufficient luminance in its front direction (a normal line direction), since the ratio of the area of the adhesive region (i.e., a ratio (%) of the total contact area of the protrusions and the adhesive layer to the laminated area of the light-diffusing substrate and the light-collecting sheet) exceeded 25%.

### INDUSTRIAL APPLICABILITY

While any of the light diffuser plates of the present invention can be preferably used as the light diffuser plate of a surface light source device, the application thereof is not limited to such. While any of the surface light source devices of the present invention can be preferably used as a backlight for a liquid crystal display device, the application thereof is not limited to such.

1. A light diffuser plate with a light-collecting layer, comprising
a light-collecting sheet, and
a light-diffusing substrate having an uneven surface at its one side, said uneven surface having a plurality of protrusions formed thereon, and flat portions with lengths of 5 μm or more, each formed between the adjacent protrusions,
characterized in that
said light-diffusing substrate and said light-collecting sheet are laminated on and united to each other by jointing the protrusions of the uneven surface of said light-diffusing substrate to one surface of said light-collecting sheet through an adhesive layer;
air layers are formed between the adhesive layer and the flat portions of the uneven surface of said light-diffusing substrate; and
the total contact area of the protrusions and the adhesive layer is from 1 to 25% of the laminated area of said light-diffusing substrate and said light-collecting sheet.

2. The light diffuser plate with the light-collecting layer, according to claim 1, wherein the height of each of the protrusions is set to be higher than the thickness of the adhesive layer, and wherein said light-diffusing substrate and said light-collecting sheet is laminated on each other so that the adhesive layer is not allowed to contact the flat portions of the uneven surface of said light-diffusing substrate.

3. The light diffuser plate with the light-collecting layer, according to claim 1, wherein the protrusions are disposed in a scattered state in plan view on the entire uneven surface.

4. A surface light source device comprising the light diffuser plate with the light-collecting layer, defined in any one of claims 1 to 3, and a plurality of light sources disposed on the rear side of said light diffuser plate, characterized in that said light-collecting sheet of said light diffuser plate is disposed on the front side.

5. A liquid crystal display device comprising the light diffuser plate with the light-collecting layer, defined in any one of claims 1 to 3, a plurality of light sources disposed on the rear side of the light diffuser plate, and a liquid crystal panel disposed on the front side of the light diffuser plate, characterized in that the light-collecting sheet of the light diffuser plate is disposed on the front side.
